(19) United States
(12) Patent Application Publication
(10) Pub. No.: US 2009/0046359 A1
(43) Pub. Date: Feb. 19, 2009

(54) Microscope

(75) Inventors: Yasujiro Kiyota, Tokyo (JP); Takayuki Uozumi, Machida-shi (JP); Nobuhiko Maiya, Yokohama-shi (JP); Hirofumi Shiono, Fujisawa-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/889,470

(22) Filed: Aug. 14, 2007

(51) Int. Cl. G02B 21/00

(52) U.S. Cl. 359/383; 359/368

(57) ABSTRACT

A microscope, in the microscope for observing a sample cultured with a culture vessel, can automatically obtain information about growing conditions of the sample. For this purpose, the microscope is a microscope for observing a sample cultured with a culture vessel, and includes a focusing unit focusing on at least two faces including a first face where the sample exists in the culture vessel and a second face differing from the first face based on predetermined conditions, and an imaging unit imaging for the first face and the second face to create images.

### BACKGROUND

1. Field

The present invention relates to a microscope for observing a sample that is cultured with a culture vessel.

2. Description of the Related Art

Conventionally, incubators are known as an automatic culture apparatus (see, for example, Japanese Unexamined Patent Application Publication No. 2004-180675). In such incubators, a culture vessel is automatically stored and conveyed. A microscope is used when observing a sample being cultured in such an incubator, and, further, automatic observation by imaging with an electronic camera is also conducted.

Usually, in observation with a microscope, only the bottom face of a culture vessel where the sample exists is targeted as an object. However, the growing condition of the sample can not be accurately grasped only from the observation information about the bottom face of the culture vessel.

### SUMMARY

The present invention aims to provide a microscope for observing a sample being cultured with a culture vessel, wherein the microscope can automatically obtain information about the growing condition of the sample.

In order to achieve the aforementioned purpose, the microscope of the present invention is a microscope for observing a sample being cultured in a culture vessel, the microscope being provided with a focusing unit focusing on at least two faces, that is, a first face on which the sample exists and a second face that is different from the first face based on a predetermined condition in the culture vessel, and an imaging unit capturing images an image on the first face and the second face to create images.

Preferably, the focusing unit may focus on at least one face, as the second face, among the surface of the culture vessel, the surface of a culture medium used for the culture, and an intermediate face existing between the surface of the culture medium and the first face and being determined according to the type of the sample.

Additionally, preferably, the focusing unit may determine the second face according to at least one among the type of the culture vessel, the type of the sample and the amount of the culture medium used for the culture, and focusing.

Preferably, the microscope may be set up inside the incubator for culturing the sample with the culture vessel in a constant temperature-room having been controlled to predetermined circumstance conditions.

### BRIEF DESCRIPTION OF THE DRAWINGS

The nature, principle, and utility will become more apparent from the following detailed description when read in conjunction with the accompanying drawings in which like parts are designated by identical reference numbers, in which:

FIG. 1 is a block diagram showing a constitution of a microscope of the present embodiment;

FIG. 2A is a drawing for illustrating a culture vessel;

FIG. 2B is a drawing for illustrating the surface of the culture vessel;

FIG. 3 is a flowchart showing the operation of the microscope of the present embodiment;

FIG. 4A is a cross-section of a 35 mm dish being the culture vessel; and

FIG. 4B is an enlarged view of a part of the cross-section of the 35 mm dish being the culture vessel.

### DETAILED DESCRIPTION OF THE EMBODIMENTS

Hereinafter, the embodiment of the present invention will be described in detail using the drawings.

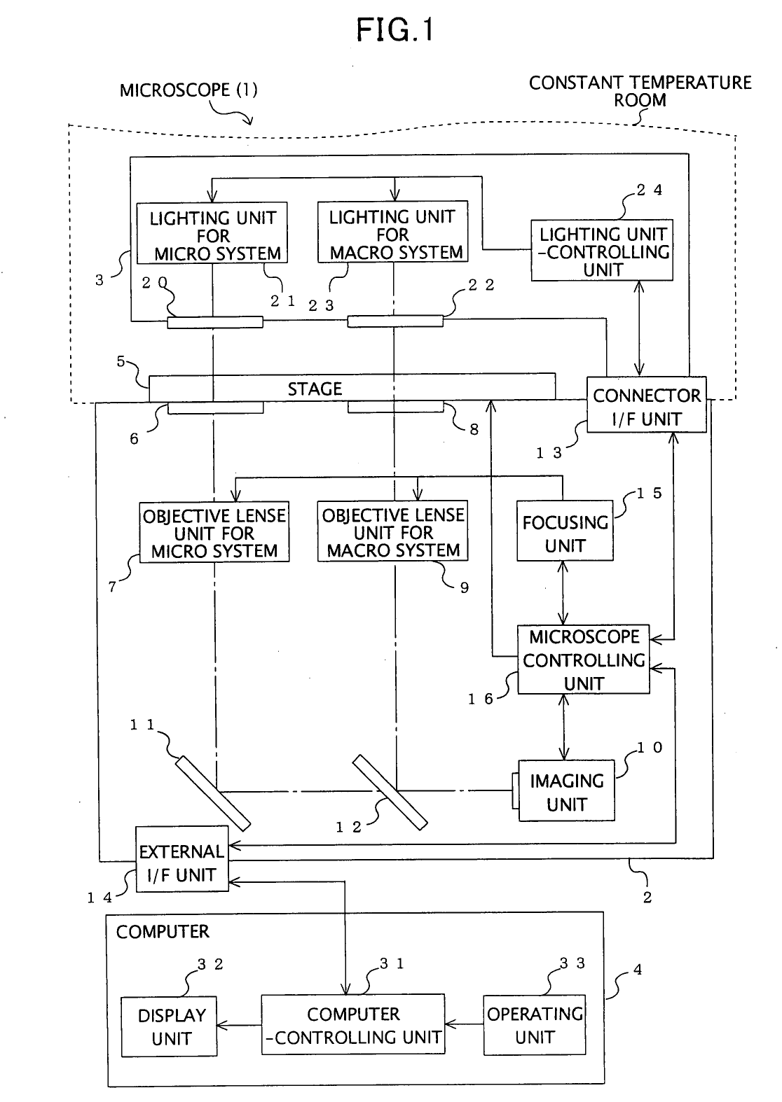

FIG. 1 is a block diagram showing the constitution of the microscope according to the embodiment of the present invention. As shown in FIG. 1, a microscope 1 is constituted of a microscope main body 2, a lighting unit 3, and a computer 4.

The microscope 1 is so constituted that it can observe a micro system and a macro system. The microscope main body 2 includes a stage 5 for leaving a sample to be observed at rest, an objective glass unit for micro system 6, an objective lens unit for micro system 7, an objective glass unit for macro system 8, an objective lens unit for macro system 9, an imaging unit 10, a mirror 11 for guiding light flux from the objective lens unit for micro system 7 to the imaging unit 10, and a mirror 12 for guiding light flux from the objective lens unit for macro system 9 to the imaging unit 10. The microscope main body 2 also includes a connector I/F unit 1 3 capable of being connected mutually with the lighting unit 3, an external I/F unit 14 capable of being connected mutually with the computer 4, a focusing unit 15 for conducting the focusing, and a microscope controlling unit 16 for controlling respective sections. The microscope controlling unit 16 is connected mutually with the imaging unit 10, the connector I/F unit 13, the external I/F unit 14 and the focusing unit 15, and controls the stage 5.

The objective lens unit for micro system 7 includes an objective lens, an objective lens-driving section, an intermediate variable magnification section and the like. It may have such constitution that plural objective lenses are provided and can be used by switching them. The objective lens unit for macro system 9 includes an objective lens, an objective lens-driving section and the like. The imaging unit 10 includes an image pickup device, and an image processing section for conducting image processing such as A/D conversion.

The lighting unit 3 includes a lighting glass unit for micro system 20, a lighting unit for micro system 21, a lighting glass unit for macro system 22, and a lighting unit for macro system 23. Each of the lighting unit for micro system 21 and the lighting unit for macro system 23 includes a light source such as an LED, a collective lens, an aperture, a mirror and the like. The lighting unit 3 also includes a lighting unit-controlling section 24 for controlling the lighting glass unit for macro system 22 and the lighting unit for macro system 23. The lighting unit-controlling section 24 is connected with the microscope controlling unit 16 via the connector I/F unit 13, and controls the lighting unit for micro system 21 and the lighting unit for macro system 23 according to directions from the microscope controlling unit 16.

The computer 4 includes a computer-controlling unit 31, a display unit 32 and an operating unit 33, accepts directions relating to the operation of the microscope 1 from a user via the operating unit 33 and displays images obtained from the microscope 1 on the display unit 32. The computer-controlling unit 31 also records previously programs for controlling respective sections in memory (not shown). Further, the computer-controlling unit 31 is connected with the microscope controlling unit 16 via the external I/F unit 14, to obtain images generated by the imaging unit 10 from the microscope controlling unit 16 and control the microscope controlling unit 16.

The microscope 1 is set up in an incubator (not shown). Further, among the constituents of the microscope 1, the lighting unit 3 and the stage 5 are set up in a constant temperature room in the incubator. This constitution makes it possible to conduct the observation without changing the controlled circumstance conditions. To the stage 5, the culture vessel of the sample to be observed is conveyed by a conveying system (not shown). The constitution of the conveying system is the same as those in publicly known techniques, therefore the description thereof is omitted.

In the observation of the micro system, illumination light is irradiated to the culture vessel left at rest on the stage 5 from the lighting unit for micro system 21, then the transmitted light, which has passed through the lighting glass unit for micro system 20, the culture vessel, the objective glass unit for micro system 6 and the objective lens unit for micro system 7 in turn and has been reflected from the mirror 11, is imaged by the imaging unit 10. In the observation of the macro system, illumination light is irradiated to the culture vessel left at rest on the stage 5 from a lighting unit for macro system 23, then the transmitted light, which has passed through the lighting glass unit for macro system 22, the culture vessel, the objective glass unit for macro system 8 and the objective lens unit for macro system 9 in turn and has been reflected from the mirror 12 is imaged by the imaging unit 10.

The microscope controlling unit 16 conducts the focusing by moving the stage 5 in the vertical direction to change the face to be an object of the focusing, and by moving a part of the objective lens unit for micro system 7 or the objective lens unit for macro system 9 in an optical axis direction of the objective lens via the focusing unit 15. Incidentally, the focusing is conducted in the same way as in publicly known techniques, therefore the description thereof is omitted.

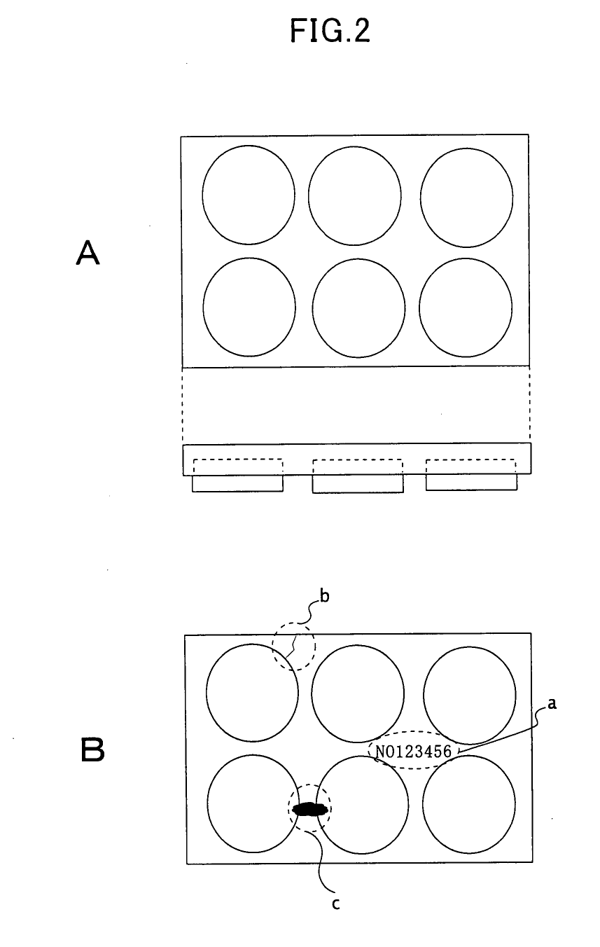

FIGS. 2A and 2B show an example of the culture vessel to be observed by the microscope 1 of this embodiment. The culture vessel shown in FIG. 2A is a 35 mm dish.

Such a culture vessel as a well plate or a flask may be used if it can be conveyed onto the stage 5 with a conveying system (not shown). In what follows, a case, where cells having been cultured with a liquid culture medium using the 35 mm dish shown in FIG. 2A as a culture vessel is observed with the microscope 1, is described as an example.

Hereinafter, the observation of the macro system being the feature of the present invention will be described using the drawings. As the result of the observation of the macro system, information about the growing condition of the sample can be obtained.

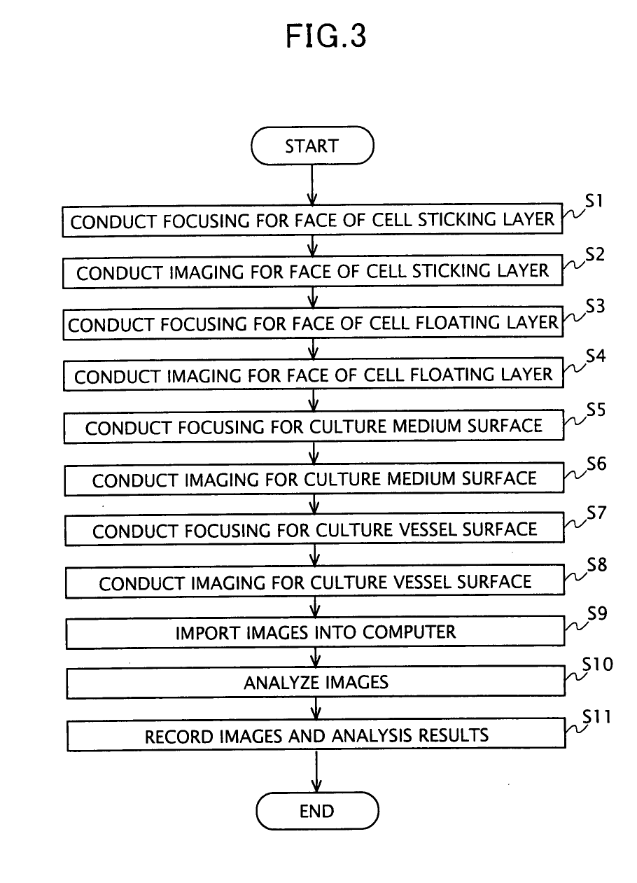

FIG. 3 is a flow chart showing the operation of the microscope 1 upon observing the macro system. Upon the observation, it is assumed that such information as the type of the sample to be observed, the type of the culture vessel and the amount of the culture medium used for the culture, and further, when there exist plural culture vessels, the observation order and the observation schedule (for example, once a day) has been previously specified by a user. These types of information can be designated in the same way as in conventional automatic culture apparatuses, therefore the description thereof is omitted.

In Step S1, the computer-controlling unit 31 conducts the focusing for a face of cell sticking layer via respective sections.

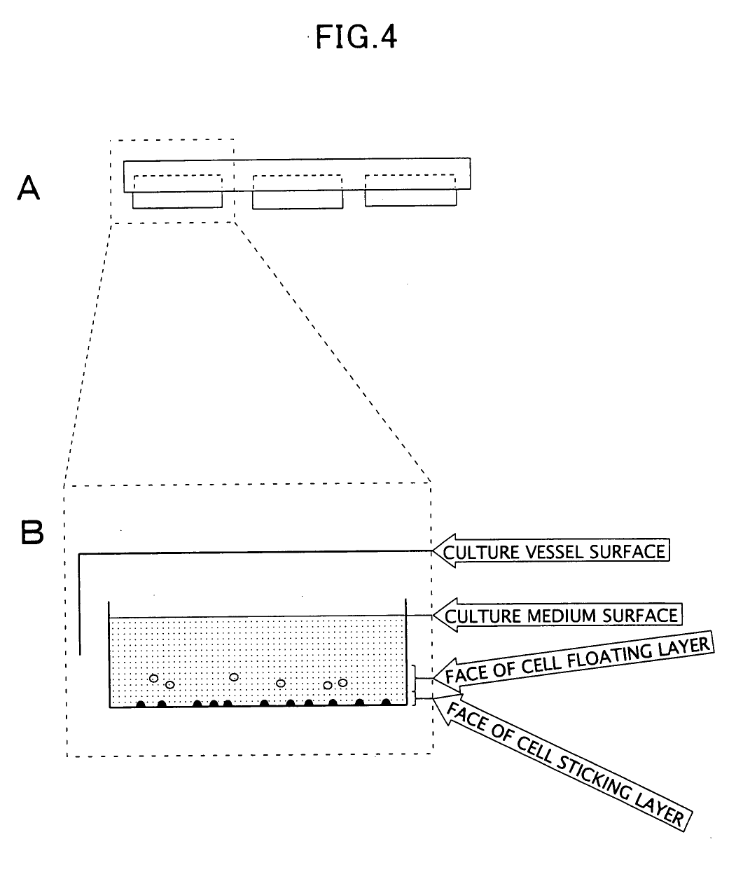

FIG. 4A is a cross-sectional view of a 35 mm dish being a culture vessel, and FIG. 4B is an enlarged view of a part of the FIG. 4A. The face of cell sticking layer means a face near the bottom face of the culture vessel, as shown in FIG. 4B. The computer-controlling unit 31 determines the face of cell sticking layer based on the type of the sample, the type of the culture vessel and the like, and moves the stage 5 in the vertical direction via the external I/F unit 14 and the microscope controlling unit 1 6 to set the face of cell sticking layer as a face to be the object of the focusing. The determination of the face of cell sticking layer based on the type of the sample, the type of culture vessel and the like is achieved by recording previously tables and calculation formulae in memory (not shown) of the computer-controlling unit 31.

Then, the computer-controlling unit 31 controls the objective lens unit for macro system 9 via the external I/F unit 14, the microscope controlling unit 16 and the focusing unit 15, to conduct the focusing for the face of cell sticking layer. The focusing may be conducted by any method such as image AF by a climbing system and active AF.

In Step S2, the computer-controlling unit 31 controls the imaging unit 10 via the external I/F unit 14 and the microscope controlling unit 16, and conducts imaging for the face of cell sticking layer.

In Step S3, the computer-controlling unit 31 conducts the focusing for a face of cell floating layer via respective sections.

The face of cell floating layer means an intermediate face between the face of cell sticking layer and an after-mentioned culture medium surface, as shown in FIG. 4B. It is generally known that dead cells and weak cells do not stick to the face of cell sticking layer but float in the culture medium. The face of cell floating layer is a face where such floating cells are presumed to exist. The computer-controlling unit 31 determines the face of cell floating layer based on the type of the sample (in particular the size of the cell), the type of the culture vessel, the amount of the culture medium and the like, and then changes the object for the focusing from the face of cell sticking layer to face of cell floating layer by moving the stage 5 in the vertical direction via the external I/F unit 14 and the microscope controlling unit 16. The determination of the face of cell floating layer based on the type of the sample, the type of the culture vessel, the amount of the culture medium and the like is achieved by recording previously tables and calculation formulae in the memory (not shown) of the computer-controlling unit 31, as is the case for the determination of the face of cell sticking layer.

Then, the computer-controlling unit 31 controls respective sections in the same way as in Step S1 to conduct the focusing for the face of cell floating layer. It is also possible to calculate the defocusing amount of the outline of a cell to conduct AF after recognizing that the height of a cell sticking to the face of cell sticking layer is exceeded.

In Step S4, the computer-controlling unit 31 controls the imaging unit 10 via the external I/F unit 14 and the microscope controlling unit 16 to conduct the imaging for the face of cell floating layer.

In Step S5, the computer-controlling unit 31 conducts the focusing for a culture medium surface via respective sections.

The culture medium surface is a surface of the culture medium used for the culture, as shown in FIG. 4B. The computer-controlling unit 31 determines the culture medium surface based on the type of the culture vessel, the amount of the culture medium and the like, and moves the stage 5 via the external I/F unit 14 and the microscope controlling unit 16 in the vertical direction to change the object for the focusing from the face of cell floating layer to the culture medium surface. The determination of the culture medium surface based on the type of the culture vessel, the amount of the culture medium and the like is achieved by recording previously tables and calculation formulae in the memory (not shown) of the computer-controlling unit 31, as is the case for the determination of the face of cell sticking layer.

Then, the computer-controlling unit 31 controls respective sections in the same way as in Step S1 to conduct the focusing for the culture medium surface. It is also possible to conduct AF by utilizing the change of image contrast at the surface interface on the culture medium.

In Step S6, the computer-controlling unit 31 controls the imaging unit 10 via the 20 external I/F unit 14 and the microscope controlling unit 16, and conducts the imaging for the culture medium surface.

In Step S7, the computer-controlling unit 31 conducts the focusing for culture vessel surface via respective sections.

The culture vessel surface means the upper surface of the culture vessel, as shown in FIG. 4B. The computer-controlling unit 31 determines the culture vessel surface based on the type of the culture vessel, the height of the cover and the like, and moves the stage 5 in the vertical direction via the external I/F unit 14 and the microscope controlling unit 16, to change the object for the focusing from the culture medium surface to the culture vessel surface. The determination of the culture vessel surface based on the type of the culture vessel, the height of the cover and the like is achieved by recording previously tables and calculation formulae in the memory (not shown) of the computer-controlling unit 31, as is the case for the determination of the face of cell sticking layer.

Then, the computer-controlling unit 31 conducts the focusing for the culture vessel surface while controlling respective sections in the same way as in Step S1. Incidentally, when a letter or the like is marked on a part of the cover of the culture vessel, it is also possible to conduct AF for the letter.

In Step S8, the computer-controlling unit 31 controls the imaging unit 10 via the external I/F unit 14 and the microscope controlling unit 16, and conducts the imaging for the culture vessel surface.

In Step S9, the computer-controlling unit 31 imports images created in Step S2, Step S4, Step S6 and Step S8 via the microscope controlling unit 16 and the external I/F unit 14.

In Step S10, the computer-controlling unit 31 analyzes the imported images. The computer-controlling unit 31 conducts the analysis on following items.

(1) Analysis of the Image of the Face of Cell Sticking Layer Imaged in Step S2

The computer-controlling unit 31 analyzes the image of the face of cell sticking layer to detect the congestion degree of the cell and the density of the cell. The congestion degree of the cell shows the local sparse or crowded state of the cell in the culture medium, which becomes uniform when the growing condition is good. The density means an area where the cell exists relative to the area of the culture medium, which becomes higher along with the proceeding of the growth.

(2) Analysis of the Image of the Face of Cell Floating Layer Imaged in Step S4

The computer-controlling unit 31 analyzes the image of the face of cell floating layer and detects the number of dead cells to obtain the death rate.

(3) Analysis of the Image of the Culture Medium Surface Imaged in Step S6

The computer-controlling unit 31 analyzes the image of the culture medium surface and detects the cloudiness degree of the culture medium to detect the existence or nonexistence, and degree of contamination. When the culture medium contains such indicator as phenol red, the section 31 detects the hue and presumes the pH of the culture medium.

(4) Analysis of the image of the culture vessel surface imaged in Step S8

The computer-controlling unit 31 analyzes the image of the culture vessel surface and detects textual information, the existence or nonexistence of cross-contamination and the like. As shown in the part surrounded with a dotted line “a” in FIG. 2B, when textual information is marked, the section 31 obtains the textual information. In addition, as shown in the part surrounded with a dotted line “b” in FIG. 2B, when such damage as crack is observed for culture vessel, the section 31 recognizes the existence of the damage. Further, as shown in the part surrounded with a dotted line “c” in FIG. 2B, when the spilth of the culture medium is observed, the section 31 recognizes the existence of such probability that cross-contamination has occurred.

(5) Multiple Analyses

The computer-controlling unit 31 presumes subculture timing and the change timing of the culture medium based on the congestion degree of the cell and the density of the cell described in (1), the pH of the culture medium described in (3) and the like. When conducting the presumption, it is necessary to know the transition of the growing condition, and, by comparing the image observed this time with respective images having been observed previously, the subculture timing and the change timing of the culture medium are presumed.

In Step S11, the computer-controlling unit 31 records the image imported in Step S9 and the analysis result of the analysis conducted in Step S10 in a recording section (not shown). The recording is conducted while correlating the image with the analysis result along with such information as observation date and time.

On this occasion, it is also possible to let the user know about the analysis result, or to give a caution to the user based on the analysis result. For example, the subculture timing or the change timing of the culture medium may be notified to the user. Also, the caution may be given to the user when the death rate exceeds a certain value, and contamination, cross-contamination or damage occurs. The notification and caution may be given by utilizing such sound information as a buzzer, or by utilizing such visual information as textual information and a lamp. Further, e-mail may be utilized to give the notification and caution.

When recording information, various types of information may be formed into databases. For example, for the purpose of grasping the transition of the growing condition, a graph together with previous observation results may be drawn.

As described above, according to the present embodiment, focusing is conducted for at least two faces including a first face, where the sample exists in a culture vessel, and a second face differing from the first face based on predetermined conditions, and then imaging is conducted for the first face and the second face to create images. Accordingly, from the comparison and investigation of these images, the information about the growing condition of the sample can be obtained automatically.

Further, according to the present embodiment, the focusing is conducted for at least one face as the second face, which are among the surface of the culture vessel, the surface of the culture medium used for the culture, and an intermediate face that exists between the surface of the culture medium and the first face and is determined according to the type of the sample. Accordingly, when the surface of the culture vessel is chosen as the second face, it is possible to obtain information about letters written on the surface, information about existence or nonexistence of cross-contamination due to the spilth of the culture medium, and the like. Also, when the surface of the culture medium used for the culture is chosen as the second face, such information can be obtained as the existence or nonexistence of contamination caused by fungi and the hue of the culture medium. When the intermediate face is chosen as the second face, such information can be obtained as the state of dead cells.

According to the present embodiment, the second face is determined according to at least one of the type of the culture vessel, the type of the sample and the amount of the culture medium used for the culture, and the focusing is conducted. Accordingly, the focusing for the second face can be practiced promptly.

According to the present embodiment, the microscope is set up inside an incubator for culturing the sample with the culture vessel in a constant temperature room having been controlled to predetermined circumstance conditions. Accordingly, information about the growing condition of the sample can be obtained without changing the controlled circumstance conditions.

Incidentally, in the present embodiment, the example is shown in which the surface to be the object of the focusing is changed by moving the stage 5 in the vertical direction, but the surface to be the object for the focusing may be changed by moving another part (such as the imaging unit 10). Further, the example is shown in which the determination of the surface to be the object for the focusing is achieved by recording previously tables and calculation formulae, but it may be achieved by another method. Furthermore, a face other than four faces shown in FIG. 4 may be additionally chosen as the object for the focusing.

In the present embodiment, the example, in which the focusing is conducted by moving a part of the objective lens unit for micro system 7 or the objective lens unit for macro system 9 in the optical axis direction of the objective lens, but the focusing may be conducted by moving another part (such as the stage 5).

In the present embodiment, the example is shown in which AF is conducted after moving to respective faces, but the AF may be omitted to simplify the operation. Further, an upper and a lower limits may be set when the AF is conducted. For example, in the case of the focusing for the face of cell sticking layer, by setting the upper and the lower limits based on the size of the cell, the shortening of the time necessary for the AF can be expected. Furthermore, for example, in the case of the focusing for the face of cell floating layer, it is possible to set the lower limit in accordance with the face of cell sticking layer, and to set the upper limit in accordance with the culture medium surface and the size of the cell.

In the present embodiment, the microscope 1 provided with a micro-observing system and a macro-observing system in adjacent places is described as the example, but the microscope may be provided with only the macro-observing system, or provided with a micro-observing system and a macro-observing system in separate places.

In the present embodiment, the example is shown in which cells cultured with a liquid culture medium are observed with transmission illumination, but the present invention can be also applied to a case where a sample cultured with a solid culture medium is observed, or a case where the observation is conducted with reflected illumination, too.

In the present embodiment, the microscope 1 set up in an incubator is described as the example, but the present invention is not limited to the example. Further, in the present embodiment, the example is shown in which the lighting unit 3 and the stage 5 are set up in a constant temperature-room in an incubator, but the present invention can be arbitrarily applied in accordance with the constitution of a microscope or an incubator.

In the present embodiment, the example is shown in which images are analyzed with the computer 4 after the end of the imaging by the imaging unit 10, but an embodiment may be so constituted that only the recording is conducted after the end of the imaging by the imaging unit 10 and the analysis is conducted later. Further, the analysis of images may be conducted with another computer.

The many features and advantages of the embodiments are apparent from the detailed specification and, thus, it is intended by the appended claimed to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A microscope comprising:
a microscope unit having an observing system and observing a sample cultured with a culture vessel in a culture device under predetermined conditions:
an image pickup unit capturing an observing image of said sample;
a focusing unit performing focusing of said observing system;
a controlling unit controlling said image pickup unit and said focusing unit to adjust a focus face of said observing system on a first face on which said sample exists in said culture vessel and a second face differing from said first face, to obtain observing images of said first face and said second face, and to memorize images of said observing images, said second face being one of a surface of a culture medium used for said culture, a surface of said culture vessel, and an intermediate face existing between said first face and a surface of said culture medium; and
an analyzing unit analyzing and obtaining at least one information of growing condition of said sample, subculture timing of said sample, changing timing of said culture medium, and contamination in said culture device based on the images of said observing images of the first face and the second face memorized in said controlling unit.

2. (canceled)

3. The microscope according to claim 1, wherein said focusing unit determines said second face according to at least one among a type of said culture vessel, a type of said sample and an amount of culture medium used for said culture, and focusing.

4. The microscope according to claim 1, wherein said microscope unit is set up inside an incubator culturing said sample in said culture vessel in a constant temperature-room having been controlled to predetermined circumstance conditions.

5. The microscope according to claim 1, further comprising an informing unit giving either a notification to a user about an analysis result of said analyzing unit or a caution to the user based on the analysis result, by at least one of sound information, text information, and visual information.

6. A microscope comprising:
a microscope unit having an observing system, which includes a macro-observing system and a micro-observing system, and observing a sample cultured with a culture vessel in a culture device under predetermined conditions;
an image pickup unit capturing an observing image of said sample;
a focusing unit performing focusing of said observing system;
a controlling unit controlling said image pickup unit and said focusing unit to adjust a focus face of said observing system on a first face on which said sample exists in said culture vessel and a second face differing from said first face, to obtain observing images of said first face and said second face, and to memorize images of said observing images, said second face being one of a surface of a culture medium used for said culture, a surface of said culture vessel, and an intermediate face existing between said first face and a surface of said culture medium; and
an analyzing unit analyzing and obtaining at least one information of growing condition of said sample, subculture timing of said sample, changing timing of said culture medium, and contamination in said culture device based on the images of said observing images of the first face and the second face obtained by said macro-observing system of said microscope unit.

7. The microscope according to claim 6, wherein said focusing unit determines said second face according to at least one among a type of said culture vessel, a type of said sample and an amount of culture medium used for said culture, and focusing.

8. The microscope according to claim 6, wherein said microscope unit is set up inside an incubator culturing said sample in said culture vessel in a constant temperature-room having been controlled to predetermined circumstance conditions.

9. The microscope according to claim 6, further comprising an informing unit giving either a notification to a user about an analysis result of said analyzing unit or a caution to the user based on the analysis result, by at least one of sound information, text information, and visual information.
